(19) United States
(12) Patent Application Publication
(10) Pub. No.: US 2005/0141154 A1
(43) Pub. Date: Jun. 30, 2005

(54) Power averaging and power load management system

(75) Inventors: Franco Consadori, Salt Lake City, UT (US); Kenneth E. Otto, Salt Lake City, UT (US)

Correspondence Address: BANNER & WITCOFF, LTD., 28 STATE STREET, 28th FLOOR, BOSTON, MA, 02109-9601, US

(73) Assignee: Atwood Industries, Inc., Rockford, IN (US)

(21) Appl. No.: 11/003,097

(22) Filed: Dec. 3, 2004

Related U.S. Application Data
(60) Provisional application No. 60/526,715, filed on Dec. 3, 2003.

(51) Int. Cl. H02H 3/00

(52) U.S. Cl. 361/62

(57) ABSTRACT

A power and load management system for a recreational vehicle provides a power distribution panel comprising a distribution controller operative to generate distribution control signals including at least load signals corresponding to the power load demands on the power distribution panel and distribution relay control signals, and an automatic transfer switch (ATS). The ATS has multiple power inputs, each operative to be connected to one of multiple power sources, e.g., shore power, a battery bank, a generator, etc., and two power transfer lines to the power distribution switch. The ATS further comprises multiple relays, each controllable independently of the others by an ATS controller to connect a corresponding one of the power transfer lines to a selected one of the available power inputs to feed power to the power distribution panel. The ATS further has multiple sensors, each operative to generate a power availability signal to the ATS controller corresponding to the availability of power on a corresponding one of the power input lines. The ATS controller is operative to receive load signals from the distribution controller and power availability signals from the ATS sensors, and to generate the power transfer control signals to the ATS relays and ATS signals to the distribution controller corresponding to power availability. The power distribution panel further comprises independently controllable distribution relays to connect each of the power transfer lines to power load(s).

This application claims the priority benefit of U.S. provisional patent application Ser. No. 60/526,715 filed on Dec. 3, 2003, entitled Power Averaging And Power Load Management System.

### FIELD OF THE INVENTION

This invention relates to power management systems. In particular the invention relates to power averaging and power load management in recreational vehicles.

### BACKGROUND OF THE INVENTION

Previously, power systems in recreational vehicles used alternating current (AC) power provided either from an outside source (shore) or from a generator on the recreation vehicle. An inverter can also be used in conjunction with one or more batteries to provide additional AC power. A converter may be used to provide direct current (DC) power when AC power is available. One or more batteries can also be used to provide DC power.

It is a problem with certain conventional systems that oversized generators are needed to meet short term peak demands. Other problems include improper battery utilization and poor utilization of multiple sources of AC power. Fixed and separate AC power distribution can leave available power underutilized. Energy management limited to power load shedding, reliance on DC power from a battery for peak or critical power loads, and underutilization of additional power sources, such as the vehicles alternator, all present underireable shortcomings in some or all known systems.

A power system for a recreational vehicle is needed, that reduces or wholly overcomes some or all of the difficulties inherent in prior known systems. Particular objects and advantages of the invention will be apparent to those skilled in the art, that is, those who are knowledgeable or experienced in this field of technology, in view of the following disclosure of the invention and detailed description of certain preferred embodiments.

### SUMMARY

In accordance with one aspect, a power and load management (PALM) system, also referred to as a power distribution system, for a recreational vehicle, sometimes referred to, for convenience, as an “RV,” comprises:
a power distribution panel comprising a distribution controller operative to generate distribution control signals including at least distribution relay control signals, and a power transfer switch, also referred to as an automatic transfer switch or ATS, comprising:
   i. multiple power inputs, each operative to be connected to a power source;
   ii. two power transfer lines to the power distribution switch;
   iii. multiple ATS relays, each controlled independently by power transfer control signals to connect and disconnect one of the power inputs to one of the power transfer lines, at least one of ATS relays being controllable to selectively connect any one of multiple power inputs to one of the power transfer lines;
   iv. multiple ATS sensors, each operative to generate a power availability signal corresponding to the availability of power on a corresponding one of the power input lines; and
   v. an ATS controller operative
      to receive power availability signals generated by the ATS sensors, and
      to generate the power transfer control signals to independently control the ATS relays in response to at least the power availability signals, and
      to generate ATS signals to the distribution controller corresponding to power availability to the power distribution switch via the power transfer lines.
         The power distribution panel further comprises:
a set of distrbution relays, each controlled independently of the others in response to at least distribution relay control signals from the distribution controller, to selectively connect and disconnect each of the power transfer lines to any one or more of multiple power loads; and
a set of current sensors, each operative to generate a current draw signal corresponding to the current drawn by a corresponding power loads.
   The distribution controller is in communication at least with the ATS controller, the distribution relays and the current sensors, and is operative to generate the distribution relay control signals in response to at least current draw signals and ATS signals.

In accordance with another aspect, a power distribution system for a recreational vehicle comprises:
a first set of relays, each operative to select a power source from multiple available power sources for power to be distributed to a corresponding one of a plurality of power loads by the power distribution system;
a second set of relays, each in communication with a corresponding relay of the first set of relays and operative to selectively drop a corresponding one of the plurality of power loads from the distribution system;
a set of current sensors, each operative to generate a signal in response to the current being drawn by a corresponding one of the power loads on the distribution system;
a set of power load sensors, each operative to generate a signal in response to a corresponding one of the plurality of power loads on the distribution system; and
a distribution controller in communication with the first and second sets of relays and the current and power load sensors, operative in response to signals received by the controller from corresponding ones of the current and power load sensors
   to control each of the relays of the first set of relays, independently of others of the relays of the first set of relays, to select a power source for the corresponding one of the plurality of power loads, and
   to control each of the relays of the second set of relays, independently of others of the relays of the second set of relays, to add or drop the corresponding one of the plurality of power loads from the distribution system.

In accordance with another aspect, a power and load management system for recreational vehicles comprises an ATS and distribution system as described above and a battery management system. The battery management system is in communication with the ATS and distribution system, e.g., via a car area network (CAN) over a CAN bus. The battery management system may include the battery controller and sensors, e.g., battery temperature sensors, etc, as described further below, with other components, such as the battery bank, generator, inverter, etc. being otherwise provided. Alternatively, the battery management system comprises the battery controller, sensors, relays, battery bank, generator, inverter, CAN nodes, optionally a charger, etc. all being provided. The ATS and battery management system may be referred to collectively as a power plant. Such power plant in accordance with certain exemplary embodiments is operative to select from amongst available power sources to provide power on one power transfer line to the distribution panel or, if needed and available, power from two power sources to the distribution system. Preferably the PALM system is operative to feed only two power sources simultaneously to the distribution panel (although the selection of which two from amongst more than two available power sources, such as a battery bank, generator, shore power, etc, will depend on the conditions) in view of the complexity inherent in managing more than two simultaneous power feeds to the distribution panel. In accordance with certain exemplary embodiments, the battery management system may comprise a battery bank, a generator, an inverter operative to convert DC power from the battery bank to AC power for the distribution system, a charger in communication with the distribution system so as to have power (when available) to recharge the battery bank using AC power from the distribution system, a temperature sensor operative to generate signals in response to a measured temperature of the battery bank, a voltage sensor operative to generate a signal in response to a measured voltage of the battery bank, and the battery controller (optionally referred to as a plant controller) in communication with some or all of the generator, inverter, charger, temperature sensor, voltage sensor, distribution controller and ATS controller. In accordance with certain exemplary embodiments the battery controller is operative to determine the state of charge of the battery bank and to generate a battery signal based on the state of charge to the distribution controller and/or the ATS controller. In accordance with certain exemplary embodiments, the battery controller preferably is operative to connect or disconnect the battery bank, to activate or deactivate the generator, and/or to control the charger in response to signals from the battery bank sensors, ATS controller, distribution controller, and/or other elements of the PALM system.

In accordance with another aspect, a battery management system is provided as described above. Optionally such a battery management system is provided in the absence of an ATS and/or distribution panel. In accordance with another aspect, a power plant as described above is provided. Optionally such a power plant is provided in the absence of a distribution panel.

In accordance with another aspect, a power and load management system for recreational vehicles comprises an ATS, distribution system and battery management system as described above, together with a chassis power system. The chassis power system includes a chassis power system controller, also referred to as an alternator controller, that is in communication with the ATS, distribution system and battery management system, e.g., via a CAN network over a CAN bus. In accordance with certain exemplary embodiments the chassis power system comprises an alternator, a chassis battery or engine battery in communication with the alternator, a first temperature sensor operative to generate a signal in response to a measured temperature of the battery, a second temperature sensor operative to generate a signal in response to a measured temperature of the alternator, a first voltage sensor operative to generate a signal in response to a measured voltage of the battery, a second voltage sensor operative to generate a signal in response to a measured voltage of the alternator, and the aforesaid alternator control unit in communication with the first and second temperature and voltage sensors, the other controllers of the PALM system. In accordance with certain exemplary embodiments the alternator controller is operative to control the alternator to provide power to the recreational vehicle and to recharge the battery bank of the power plant.

These and additional features and advantages of the invention disclosed here will be further understood from the following detailed disclosure of illustrative embodiments.

### BRIEF DESCRIPTION OF THE DRAWINGS

FIG. 1 is schematic illustration of an embodiment of an ATS for a power and load management system as disclosed here.

FIG. 2 is schematic illustration of an embodiment of a distribution panel for a power and load management system as disclosed here.

FIG. 3 is schematic illustration of another embodiment of a distribution panel for a power and load management system as disclosed here.

FIG. 4 is a schematic illustration of an embodiment of a power plant aspect of a power and load management system as disclosed here.

FIG. 5 is a schematic illustration of another embodiment of a PALM system in accordance with the present disclosure, comprising a monitor (user interface) providing appliance controls with CAN communications.

FIG. 6 is schematic illustration of an embodiment of the power and load management systems disclosed here, including distribution panel and ATS elements.

FIG. 7 is a schematic illustration of another embodiment of the power and load management systems disclosed here, comprising the PALM system of FIG. 6.

FIG. 8 is a schematic illustration of an embodiment of the power and load management systems disclosed here, comprising the system of FIG. 7 and an embodiment of a chassis power system in accordance with this disclosure.

The figures referred to above are not drawn necessarily to scale and should be understood to present a representation of the invention, illustrative of the principles involved. The same reference numbers are used in the drawings for similar or identical components and features shown in various alternative embodiments. Power load and management systems as disclosed herein, will have configurations and components determined, in part, by the intended application and environment in which they are used.

### DETAILED DESCRIPTION OF ILLUSTRATIVE EMBODIMENTS

Numerous alternative embodiments of the power and load management (PALM) systems disclosed here for recreational vehicles will be readily apparent to those skilled in the art given the benefit of this disclosure. With reference to any such PALM systems, the terms “subsystem,” “subsystem,” “switch” and “panel” are used interchangeably here and in the appended claims, for example in the interchangeable phrases “automatic transfer switch” and “automatic transfer system” or automatic transfer subsystem” (alternatively referred to as “power transfer sub-system” or “power transfer switch”) and, similarly, in the interchangeable phrases “distribution sub-system” and “distribution panel” etc. The term “independently” is used here and in the appended claims, for example in the phrase “multiple ATS relays, each controlled independently of the others in response to at least power transfer control signals” to mean that each of the relays (or whatever items or features are being referred to as independently controlled) can be controlled differently, e.g., opened when another is closed, or at a different time, etc. It will be understood, however, that the condition or setting or the like of one member of a set may impact the control of another. Thus, the signal or the condition of two independently controlled relays, for example, may be the same as or different from each other, but may nevertheless be impacted by or coordinated with the other. For example, a signal may be sent by the distribution controller to one of the load shedding relays of the distribution panel (or distribution switch or sub-system) to connect its power load to a power line from the ATS and another signal may be sent by the distribution controller to another of the load shedding relays to connect or disconnect its power load to the same or a different one of the power lines from the ATS. Signals may be sent to the various relays at different times or at the same time (meaning simultaneously or spaced in time as closely as the controller is capable of under the prevailing conditions of the system.) As used here, the term recreational vehicle or RV refers to a vehicle used in recreation activities. Examples of such recreational vehicles include but are not limited to campers, mobile homes, motor homes, boats, and the like. Other suitable vehicles will be apparent to one skilled in the art given the benefit of this disclosure.

In accordance with certain exemplary embodiments of the PALM systems disclosed here, an AC power distribution system for a recreational vehicle has an automated transfer switch capable of accepting multiple AC inputs, each typically less than 100 Amps e.g., each no more than 50 Amps, and one or more of them unavailable under certain circumstances, such as shore power (e.g., 30 Amps), a second shore power line (e.g., two phase/50 Amps), a generator (e.g., an on-board generator), a n on-board battery bank with an inverter. The ATS has two power output lines, i.e., two power transfer lines to a distribution panel, and so is capable of providing power to the RV over two lines simultaneously, if at least two power sources are available, including at least one source adapted to be connected by the ATS to each of the two power transfer lines. In certain embodiments the ATS may be configured to select from fewer than all possible sources for power to one of the power transfer lines. In some embodiments only a first subset of all the power sources is made available by the ATS to a first one of the power transfer line, and only a second, different subset is made available by the ATS for connection to the other power transfer line. In accordance with certain exemplary embodiments of the PALM systems disclosed here, the ATS is capable of detecting the presence of each power input (i.e., that power is available on that particular input at that time) and to communicate the availability to the Power Distribution Panel. In certain exemplary embodiments the ATS is can detect faulty wiring, e.g., hot/common faults and ground faults and the like, and is configured to prevent connection to the distribution panel if a fault is detected. In certain exemplary embodiments the ATS comprises power relays and associated actuator relays such that the ATS controller actuates a power relay to open or close power transfer to the distribution panel from an available power source by actuation of an associated actuator relay. Numerous suitable relays for use in the PALM systems disclosed here are commercially available and will be apparent to those skilled in the art given the benefit of this disclosure. In that regard, the term “relay” is intended to cover all devices which perform the intended function. Exemplary relays for power switching, for example, include contactors, solid state relays and generic power relays.

In accordance with certain exemplary embodiments of the PALM systems disclosed here, an AC power distribution panel is capable of accepting power simultaneously from either or both power transfer lines from the ATS, i.e., from one or two AC power sources, for simultaneous distribution to the AC circuits of the recreational vehicle. The distribution panel in certain exemplary embodiments has current sensors and is capable of measuring the total current draw of circuits or loads powered by the distribution panel. The AC circuits in certain exemplary embodiments are organized into two distinct types:
a. Direct Circuits: wired in a traditional manner with the added capability of measuring the total current draw of these circuits, and
b. Select Circuits: wired through relays or the like for selective or controlled connection to one of the power transfer lines from the ATS.
n accordance with certain exemplary embodiments of the PALM systems disclosed here, the distribution panel comprises relays and sensors configured for:
a. Sensing load demands and connecting each circuit if sufficient power is available;
b. Balancing source utilization by selecting appropriate source;
c. Measuring individual current draw of each circuit; and/or
d. Dropping each load if power exceeds allowable maximum for each circuit.

In accordance with certain exemplary embodiments of the PALM systems disclosed here, a battery management system is operative to improve reliability of battery power, preferably in conjunction with the use of AC inverters and DC appliances. In certain exemplary embodiments such battery management systems are capable of: any or all of the following:
a. Automatically connecting and disconnecting the batteries based on availability of sufficient power above a minimum State of Charge (SOC);
b. Measuring batteries temperature to prevent charging and discharging of batteries in inappropriate conditions;
c. Measuring batteries voltage with sufficient accuracy to allow SOC determination in rest conditions;
d. Measuring the charging and discharging current of the batteries at all times;
e. Measure rest times of batteries to allow SOC measurements as in c. above;
f. Monitoring of batteries to maintain an accurate accounting of SOC using manufacturer's charging efficiencies and a Peukert equation algorithm to properly account for discharging currents; and/or
g. Verification of accuracy of monitoring process by periodically comparing SOC data from monitoring process with SOC data from c. above.

In accordance with certain exemplary embodiments of the PALM systems disclosed here, a PALM system is implemented through individual modules connected in a CAN network. Preferably such PALM system is capable of (as needed):
a. Starting and Stopping an on-board generator;
b. Controlling air conditioning units; and/or
c. Connecting and disconnecting batteries.

In accordance with certain exemplary embodiments of the PALM systems disclosed here, a battery management system is configured to better ensure reliability of on-board battery power from a battery bank for DC appliances and other DC loads and, by an associated AC inverter, for AC appliances and other AC loads. In certain exemplary embodiments the battery management system is configured to automatically connect and disconnect the batteries based on availability of sufficient power above a minimum State of Charge (SOC). The minimum SOC can be a value pre-stored in a battery controller. In certain exemplary embodiments the battery management system is configured to measure the temperature of the batteries to prevent charging and discharging of the batteries in inappropriate conditions. The temperature range(s) for charging and discharging of the batteries can be a value pre-stored in a battery controller. In certain exemplary embodiments the battery management system is configured to measure the batteries' voltage with sufficient accuracy to allow SOC determination in rest conditions, e.g., after three hours or longer of non-use. In certain exemplary embodiments the battery management system is configured to measure the charging and discharging current of the batteries, preferably at all times, and to measure rest times of batteries to allow SOC measurements as above. In certain exemplary embodiments the battery management system is configured to monitor the battery bank to maintain an accurate accounting of SOC, e.g., using the battery manufacturer's charging efficiencies and a Peukert equation algorithm to properly account for discharging currents, and to perform tests for verification of accuracy of the monitoring process by periodically comparing SOC data from the monitoring process with SOC data determined by the aforesaid battery bank voltage measurements in rest conditions.

The automatic transfer switch (sometimes referred to here and in the appended claims as the “ATS” for convenience and brevity) of the PALM systems disclosed here, for power to at least some of the RV's loads, preferably is configured to detect power availability from each source input line and to select two of them to feed power to the distribution panel. Power is fed to the distribution panel via either or both of two power transfer lines. For example, an RV may have available any or all of the following: shore power able to provide, e.g., up to about 3600 W; an on-board (i.e., carried by the recreational vehicle) generator able to provide, e.g., up to about 3600 W; an inverter drawing power from an on-board battery bank, able to provide, e.g., up to about 1000 W; a shore generator able to provide, e.g., up to about 7200 W; and/or aura able to provide up to about 7200 W. The ATS of certain exemplary embodiments of the PALM systems disclosed here provide any or all of the following features or capabilities.
Selection or configuration from among the available power sources to feed power to the distribution panel via one or both of the power transfer lines
Power detection for all or some of the various alternative power sources.
Power monitoring, that is, the monitoring of power usage.
Power switching, that is, controlled selection, and change of selection from time to time, of the power source(s) feeding power to the distribution panel through the ATS.
Communication at least between the ATS controller and various relays and sensors of the ATS and, preferably, between the ATS controller and the distribution controller. Such communication is preferably via a local area network in the RV, referred to here as a car area network or CAN, the ATS controller preferably incorporating a CAN node in communication with a CAN bus running through the vehicle. It will be within the ability of those skilled in the art, given the benefit of this disclosure, to prepare suitable CAN communication protocols for the PALM systems disclosed here, or to adapt protocols for CANs and CAN bus communication established in the motor vehicle industry.

Various alternative embodiments of the distribution panel will be apparent in view of this disclosure. In certain exemplary embodiments of the PALM systems disclosed here, certain of the RV's loads for which a power interruption is acceptable, typically, for example, the RV's water heater or air conditioner, are fed power by the distribution panel through a load shedding relay under the control of the distribution controller. The load is shed by actuating the load shedding relay to disconnect the load from the power, in response to distribution relay control signals from the distribution panel controller. It should be understood that the load shedding relays (and any other controlled relays of the distribution panel, the ATS or other systems or sub-systems) may in certain exemplary embodiments comprise, in addition to the relay itself, a CAN node and/or an actuator coupled to the relay and responsive to signals from the associated controller to operate the relay. The actuator optionally is, e.g., a relay or other suitable device.

In certain exemplary embodiments of the PALM systems disclosed here, the distribution panel is operative to feed power to any or all of the RV's loads from either of the two power feed lines from the ATS to the distribution panel. In such embodiments the source of power for a load is selected by the corresponding distribution relay (alternatively referred to as a circuit select relay or power source selection relay) of the distribution panel under the control of the distribution controller. Certain other loads for which power is preferably always available, e.g., a circuit of electrical outlets, a refrigerator, etc., may optionally be dedicated to one or the other of the power feed lines, e.g., to a direct power line rather than a managed power line. In other exemplary embodiments, only certain loads are fed power by the distribution panel through a load shedding relay, i.e., through a controlled relay. In such embodiments certain of the loads are always powered so long as the corresponding power transfer line from the ATS has power. Various other combinations of controlled and uncontrolled relays, for shedable (or droppable) and non-shedable (or non-droppable) loads, will be apparent to those skilled in the art given the benefit of this disclosure.

Certain exemplary embodiments of distribution panels of PALM systems in accordance with this disclosure provide any or all of the following features or capabilities.
Circuit selection, that is, selection of a power transfer line from the ATS for power to a particular load. In certain exemplary embodiments it is possible to select either the first or second power transfer line for AC power feed from the ATS to a particular load. In certain exemplary embodiments it is possible to select either to connect or not to connect a particular load to a first one of the power transfer lines, with no option to connect the second power transfer line to that particular load. In certain exemplary embodiments power selection is controlled by distribution relay control signals from the distribution panel controller (referred to in some instances as the distribution controller) for each of multiple loads, e.g., for the water heater or for an air conditioner unit or for a second air conditioner circuit, or for a charger for a battery bank. The first such power feed may be, for example, direct AC power and the second may be, e.g., a managed power line. That is, in certain exemplary embodiments of the PALM systems disclosed here, certain of the RV's loads may be either connected by the distribution panel to a particular power feed line from the ATS or disconnected, but not switched from one power feed line to the other. In certain exemplary embodiments of the PALM systems disclosed here, certain of the RV's loads cannot be shed under the control of the distribution panel.
Current monitoring, that is, monitoring of current in managed and direct AC power lines.
Load sensing or monitoring, preferably load monitoring over time.
Load balancing and control, preferably including at least control by the ATS of the power source(s) selected to feed to the distribution panel and/or control by the distribution panel of the loads to connect or shed over time and from time-to-time.
Communication at least between the distribution panel controller and the various distribution panel sensors, controlled power distribution relays and preferably also with the ATS controller, preferably via a CAN. The distribution panel controller preferably incorporates a CAN node in communication with a CAN bus running through the vehicle. It will be within the ability of those skilled in the art, given the benefit of this disclosure, to prepare suitable CAN communication protocols or to adapt protocols for CANs and CAN bus communication already established in the motor vehicle industry.

In accordance with one aspect of the present disclosure, a PALM system for an RV may comprise (optionally with or without an ATS and/or distribution panel) an on-board power plant, including, e.g., a generator and/or a battery bank and inverter for providing AC power, optionally with a charger to recharge the battery bank or electrical connection to the alternators of the RV's engine. In accordance with certain exemplary embodiments, the power plant system is provided together with an ATS and distribution panel. As described further below, such power plant systems typically comprise the battery bank, inverter, battery bank management sub-system, generator, charger, sensors, etc., together with a battery management controller. Preferably, the battery management controller is operative to automatically start the generator to provide power to the RV, e.g., to recharge the battery bank when needed and/or to power various loads of the RV. Such battery management systems in accordance with this disclosure preferably provide any or all of the following battery management features or capabilities:
AC charger control for the battery bank, discussed further below;
AuraGen fast charge;
State of charge (SOC) monitoring, discussed further below;
Discharge protection; and/or
Battery disconnect.
Battery monitoring
Inverter control, including, e.g., on/off control and/or reset control, etc.
The ability to start and stop the on-board generator as needed.

The generator power output line preferably runs to the ATS. Preferably, in PALM systems comprising a controlled generator, the generator has a CAN node for communication via the RV's CAN bus. The generator and associated components may be referred to as a genset in accordance with accepted terminology. Correspondingly, the aforesaid CAN node may optionally be referred to as a genset node. The generator may be incorporated into a PALM system, e.g., as part of the battery management system, as a separate generator sub-system, or in other suitable fashion. Preferably the generator controller is operative to perform any or all of the following:
to monitor the generator's running condition; and
to communicate, preferably via CAN nodes and a CAN bus in the RV, including at least communications of the battery management controller with various sensors and controlled relays of the battery management system and/or with an ATS controller, distribution controller, etc.

Certain exemplary embodiments of the PALM systems disclosed here, specifically, those that also comprise an on-board battery bank and inverter for providing AC power and other elements of a battery bank management sub-system as part of a power plant system of a PALM system, perform battery bank state-of-charge (SOC) monitoring, for example, measurement of amperage draw over time in order to determine amp-hour usage. The battery bank of an RV is typically comprised of multiple deep-draw batteries that differ from the lead acid chassis battery(ies) of the RV's engine. In certain exemplary embodiments SOC is monitored by measuring amperage each second, averaging over time increments of 64 seconds, obtaining a power usage value from a look-up table of values pre-loaded into a battery management controller (discussed further below), and summing the values over time by the battery management controller. The look-up table values are determined empirically or, preferably, by calculation using Peukert's Equation. In certain exemplary embodiments a battery bank SOC audit is performed by the battery management controller whenever the bank has been at rest for at least a pre-set period of time, e.g., three hours. In certain exemplary embodiments the battery bank, battery management controller, inverter, charger, AC generator, various sensors and the like further described below together with the ATS controller, relays, etc. may be referred to collectively as a power plant. Correspondingly, the battery bank management controller and the ATS controller, whether or not actually housed together or otherwise combined, may be referred to collectively as a power plant controller.

Further, certain such embodiments comprising an on-board battery bank, inverter and battery bank management sub-system perform battery bank charging management, including, in certain exemplary embodiments, charging by a dedicated battery charger under the control of a battery management controller. In certain exemplary embodiments the battery bank controller controls charging of the battery bank by a dedicated charger, taking into account at least the temperature of the battery bank (preferably determined by a temperature sensor at the battery bank) and the battery bank's SOC. In certain exemplary embodiments the battery bank controller controls charging of the battery bank by the RV's engine alternator, such that it performs the same as or similar to a dedicated battery charger, taking into account at least temperature and SOC, so as to reduce over-charging and the like which may otherwise occur through the use of the RV's alternator to charge the battery bank.

Certain exemplary embodiments of the palm systems disclosed here provide a monitor, that is, a user interface suitable to be mounted in the RV. In accordance with certain exemplary embodiments, the monitor provides information to an occupant or operator of the RV, or to repair or maintenance personnel, regarding the status or condition of the PALM system. In accordance with certain exemplary embodiments, the monitor provides control features whereby an occupant or operator of the RV or repair or maintenance personnel can control settings, operating parameters or the like, e.g., temperature settings, operational preferences, etc. Certain exemplary embodiments of monitors of PALM systems in accordance with this disclosure provide any or all of the following data display features or capabilities: AC power display, DC power display, generator display, climate control display, etc. The DC power display optionally includes, for example, the state of charge of the battery bank, whether or not the battery bank is being charged, the power usage rate or level, etc. The AC power display optionally includes, for example, the power sources in use and the power level being provided by each, the power usage by any or all of the various loads, etc. The climate control display optionally includes, for example, the target temperature for the heating and cooling system, the current ambient temperature, outside temperature, etc. Preferably, the monitor displays information by gauges, on/off signal lights, and the like, and/or by use of a display screen, such as an LCD screen or the like. In certain such embodiments comprising a display screen, especially if the monitor is operative to display more information than can be conveniently displayed all together on the screen, preferably the monitor includes a screen select capability, e.g., a screen select button, touch screen location or the like, whereby a subset of the available information is selected for display at any one time. Generator control input, including, e.g., the ability to turn the generator on or off, to set or change a schedule for the generator to automatically turn on and off, and/or to change the parameters that determine when it is automatically turned on and off. Preferably, the battery management controller or plant controller of the PALM system monitors the running of the generator and controls the generator such that it will stop attempting to start the generator after three failed attempts in a row. It will be understood from this disclosure that the battery management controller (and all other controllers of the PALM system), the generator (and all other controlled components and elements of the PALM system), as well as associated sensor(s) operative to send signals from the generator to the controller (and all other sensors, etc.) have an associated CAN node for communication via the CAN bus. Certain exemplary embodiments of monitors of PALM systems in accordance with this disclosure provide any or all of the following additional features or capabilities: appliance control, including, e.g., climate control, e.g. the setting of desired temperature in the RV to be achieved by the air conditioner unit(s), furnace, etc. Thus, by way of example, in PALM systems having a monitor, the RV's furnace preferably is enabled for communication with the monitor. An exemplary furnace suitable for an RV preferably has a single or dual BTU furnace control. The associated monitor or other controller of the PALM system, in certain exemplary embodiments, is operative to turn the furnace off and on and to accept setting for same via input controls on the monitor. Additionally the furnace is controllable for selecting high/low heating, high/low vent, etc. Similarly, an air conditioning unit suitable for use in an RV equipped with a PALM system comprising a monitor, as disclosed here, preferably is controllable through the monitor with respect to at least turning the compressor on and off as needed, turning the fan to a high setting, low setting or off, turning a heat strip or heat pump on and off as needed, with communications being via a CAN node. Certain exemplary embodiments of monitors of PALM systems provide additional communication features or capabilities, including, e.g., CAN communications, that is, communications with various appliances and other PALM elements (and optionally other components of the RV) via a CAN node connected to the CAN bus.

It will be understood by those skilled in the art, given the benefit of this disclosure, that controllers are commercially available that are suitable for use as the distribution controller, the ATS controller or other controller on the PALM systems disclosed here. Suitable controllers comprise, for example, programmable microprocessors with memory as needed. Preferably each of the controllers is in the nature of a state machine which maps input signals or events (or an ordered sequence of input signals or events) into corresponding output signals or events (or an ordered sequence of corresponding output signals or events), such that a given input to a controller in a certain state results in a predetermined performance or operation by the controller. That is, the operation or performance of the controller is determined by its state and input events, and its state is determined at least in part by signals received from other controller(s) of the system, system sensors, etc.

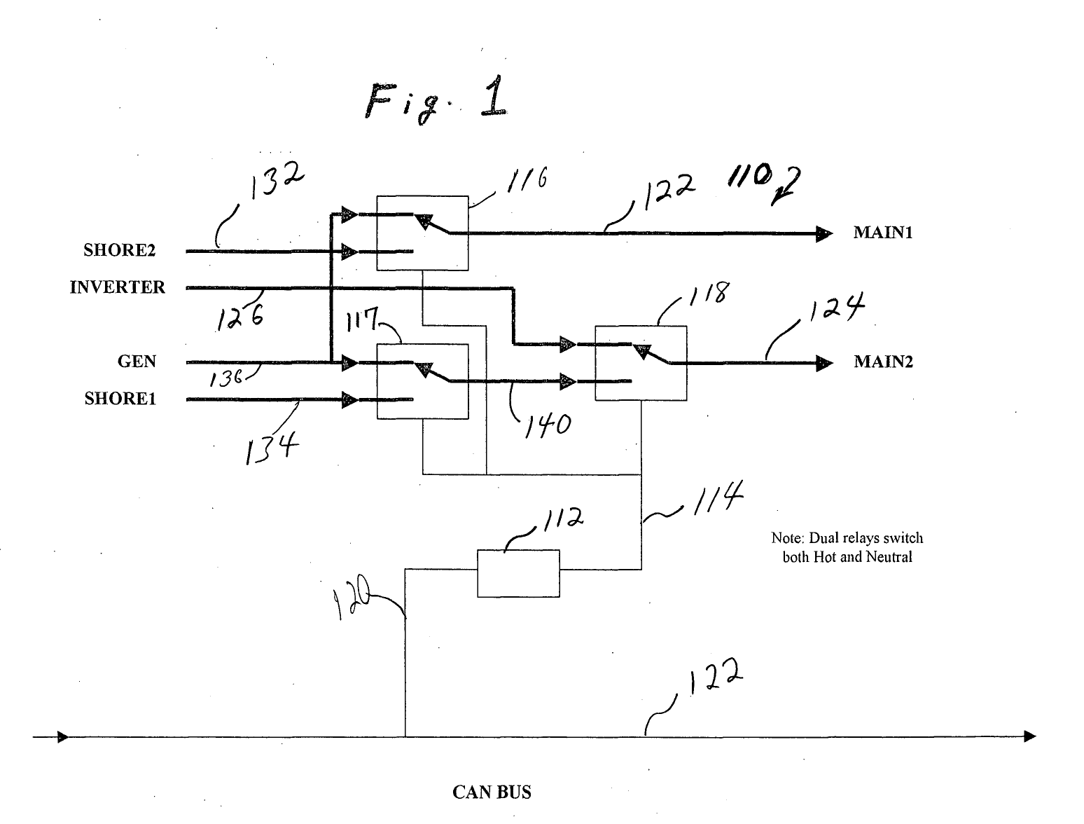

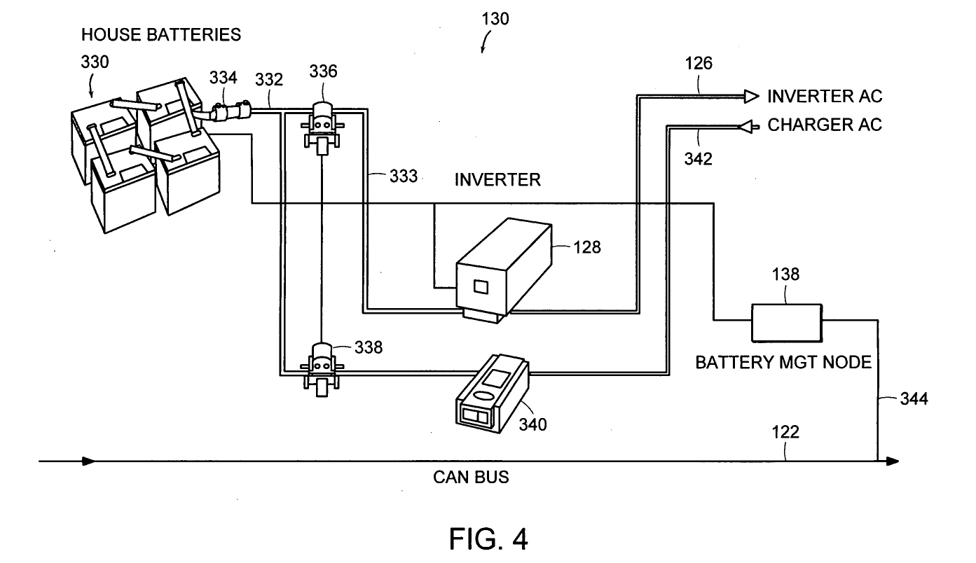

Referring now to FIG. 1, the primary components of an automatic transfer switch (ATS) 110 are illustrated schematically. The ATS controller 112 is connected by a communication line 114 to ATS relays 116-118. ATS controller 112 comprises a CAN node for communication via line 120 with a CAN bus 122 which runs throughout the RV. CAN bus 122 provides communication, e.g., between ATS controller 112 and one or more other controllers of the PALM system and, optionally other components of the RV, such as engine controllers etc. Relay 116 is associated with power transfer line 122 to a distribution panel (discussed further below) of the PALM system. Similarly, ATS relay 118 is associated with power transfer line 124 to the distribution panel. It can be seen that relay 118 is operative to connect power transfer line 124 to either of two power input lines, specifically, to power line 126 from an inverter 128 (which, as seen in FIG. 4. is included as part of a battery management system 130 discussed further below) or to power input 140. Power input 140, in turn, is then powered by relay 117. It can be seen that relay 117 is operative under the control of ATS controller 112 to feed power to line 140 from either power input line 136 or power input line 134. Power input line 134 carries shore power and power input line 136 carries AC power from an onboard generator. Optionally the onboard generator is part of the battery management system 130 under the control of the battery controller 138. Thus, acting cooperatively under the control of the ATS controller, relays 117 and 118 can feed power to power transfer line 124 to the distribution panel from a source of shore power, an onboard generator or an onboard inverter. In similar manner, relay 116 is operative under the control of ATS controller 112 to provide power to power transfer line 122 from either the onboard generator via power input line 136 or from a second shore power input line 132. It will be apparent to those skilled in the art, given the benefit of this discloser that additional relays may be incorporated in ATS 110 to provide additional power sources for the two power transfer lines 122, 124. It will be similarly apparent that the power inputs to the relays may be provided in numerous alternative arrangements.

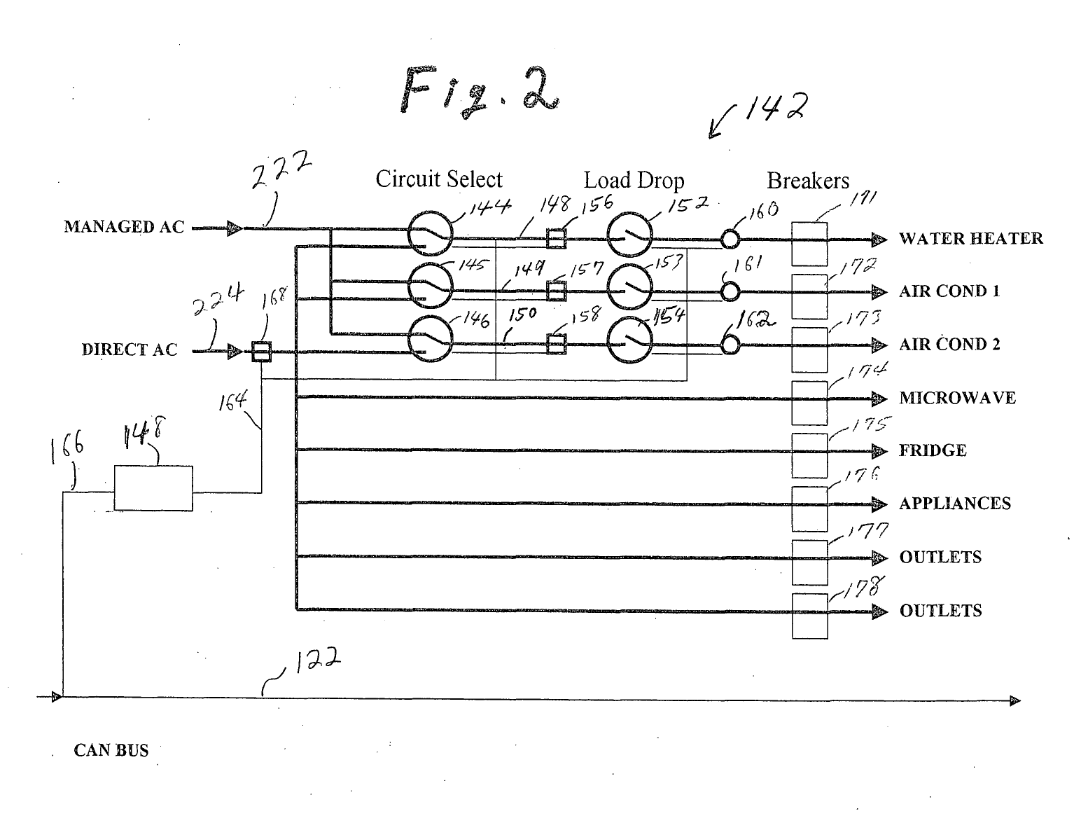

One embodiment of a distribution panel suitable for use in a PALM system as disclosed here is illustrated schematically in FIG. 2. Specifically, distribution panel 142 comprises a first set of circuit select relays 144-146. Each of these circuit select relays is operative under the control of distribution controller 148 to provide AC power via a corresponding power line 148-150 to a corresponding set of load drop relays 152-154. Each of the load drop relays provides power to a corresponding load, such as to the RV's water heater, first air conditioning unit, second air conditioning unit etc. It will be apparent to those skilled in the art, that any suitable number of circuit select relays and corresponding load drop relays may be employed in alternative embodiments of the distribution panel in FIG. 2. A circuit breaker 156-158 is provided in each of the power lines 148-150 between the circuit select relays and the load drop relays. Load sensors 160-162 are provided, one each, in each power line from the load drop relay to the associated load. Signal communication is provided from each of the load sensors, breakers and relays to distribution controller 148 via communication line 164 to distribution controller 148. Controller 148, in turn, is in communication by a line 166 with CAN bus 122 running throughout the RV. Each circuit select relay 144-146 is operative under the control of distribution controller 148 to select power from either of the two power transfer lines 222, 224 from the ATS of the PALM system. Power transfer lines 222, 224 may be, for example, the power transfer line 122, 124 of ATS 110 shown in FIG. 1. In FIG. 2, power transfer line 222 is a managed AC line and power transfer line 224 is a direct AC power line. A breaker 168 is provided in direct AC power line 224. Also, breakers 171-178 are provided in each of the power feed lines to the various system loads, such as, for example, the water heater, air conditioning units, microwave, refrigerator, appliances, electrical outlet circuits, etc. Thus, distribution panel 142 is operative to feed AC power, when available, to the various RV system loads. When power is available on one of the lines, either the managed AC power line 222 or the direct AC power 224 from the ATS, the relays are able to draw power instead from the other power transfer line. Where sufficient power is unavailable, one or more loads can be shed or dropped from the system by actuating the corresponding load drop relay under the control of distribution controller 148. In this manner, the PALM system can provide power on a priority basis when and where needed. For example, power to an air conditioning unit can be temporarily suspended where sufficient AC power is not available to meet all of the system demands. Similarly, power to one or more air conditioning units can be alternated with power to a water heater so as to maintain as nearly as possible the desired water heater temperature and climate control conditions. It will be apparent to those skilled in the art, given the benefit of this disclosure, that numerous alternative arrangements are possible for the distribution panel illustrated in FIG. 2. It will be well within the ability of those skilled in the art, given the benefit of this disclosure, to select a suitable number of relays and to assign various system loads either to direct or dedicated power feeds or to interruptible power feeds via the distribution panel under the control of the distribution controller.

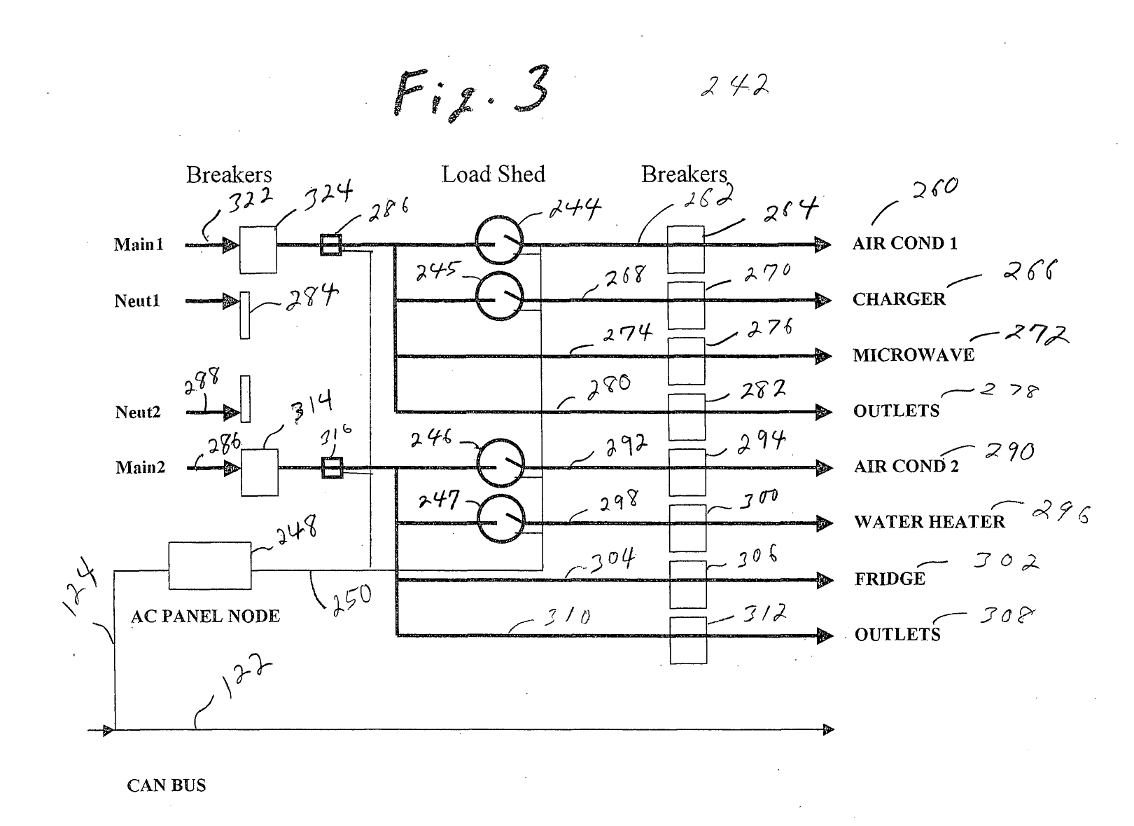

FIG. 3 illustrates an alternative embodiment of the distribution panel suitable for the use in a PALM system according to the present disclosure. Distribution panel 242 comprises load shedding relays 244-247. Distribution controller 248 communicates with relays 224-247 via signal line 250, and communicates with CAN bus 122 via communication line 224 which runs to a CAN node incorporated into controller 248. Thus, controller 248 is able to communicate with the other controller(s) of the PALM system via the CAN network. It should be noted, in addition, that in certain exemplary embodiments of the PALM systems disclosed here, one or more of the system controllers can generate signals to other vehicle components, or receive signals from such other vehicles, such as engine controllers and the like. In that regard, as mentioned above, the controllers also can communicate with a monitor incorporated into the PALM system, whereby a vehicle operator or maintenance personnel can access information about the PALM system communicated between the monitor and the various PALM system controllers. In the embodiment illustrated in FIG. 3, power transfer line 322 from an ATS of the PALM system provides AC power through breaker 324 and to a first sub-set of the system loads. More specifically, power is provided to a first air conditioning unit 260 through relay 244 via power line 262 with breaker 264. Similarly, AC power from power transfer line 322 is provided to battery charger 266 (included, perhaps, in a battery management system of the PALM system) through relay 245 via power line 268 and breaker 270. AC power from power transfer line 322 is provided to microwave 272 via line 274 and breaker 276. In that case, no load shedding relay is provided. Accordingly, power will only be provided to microwave 272 when available power transfer line 322. Likewise, power to a circuit of outlets 278 is provided directly via line 280 through circuit breaker 282, i.e., without the benefit of a load shedding relay. Power line 322 is provided with its own dedicated neutral 284. Current sensor 286 monitors the current being drawn in line 322 and generates corresponding signals to controller 288 via CAN network line 250. In similar fashion, power transfer line 286, having neutral line 288, provides power to a second air conditioning unit 290 through relay 246 via line 292 with breaker 294. Power is provided to water heater 296 through relay 247 via power line 298 having breaker 300. Power is provided from power transfer line 286 to a refrigerator 302 via power line 304 having breaker 306 and to a circuit of outlets 308 via power line 310 having breaker 312. The power to refrigerator 302 and outlet circuit 308 is direct; it does not pass through a load shedding relay under the control of distribution controller 248. Therefore, the outlet circuit and refrigerator will be powered anytime power is available from power transfer line 286. Breaker 314 is provided for power transfer line 286. Current sensor 316 monitors current on power line 286 in much the same way as described as above with respect to sensor 286 on power transfer line 322. Thus, under the control of distribution controller 248, either or both load shedding relays 246, 247 may be opened or closed depending on the needs of the PALM system for balancing and prioritizing system loads.

One exemplary embodiment of a battery management system suitable for the PALM systems disclosed here is seen in FIG. 4. Specifically, battery management system 130 is seen to comprise battery bank 330 operative to provide DC power via power line 332 equipped with shunt 334. Disconnect switches 336 and 338 are under the control of battery management controller 138. Shunt 336 is operated to connect or disconnect inverter 128 from battery bank 330. Correspondingly, shunt 338 is controlled to connect or disconnect battery bank 330 from battery charger 340. AC power is provided to battery charger 340, preferably from a distribution panel of the PALM system, via power line 342. When the state of charge of battery bank 330 is sufficient, and a need for battery power is determined by the PALM system, DC power is fed via power line 332 and 333 to inverter 128 and AC power from inverter 128 is provided, preferably as a power input line to and ATS of the PALM system. Battery controller 138, incorporating a CAN node communicates via line 344 with CAN bus 122. Controller 138 also is in signal communication with inverter 128, shunts 336, 338 and battery bank 330. Optionally, shunts 336 and 338 may share a common CAN node. In view of the present disclosure, numerous alternative arrangements will be apparent to those skilled in the art for a battery management system of the PALM systems disclosed here. For example, additional components may be included, e.g., an onboard or off-board generator under the control of battery controller 138. As discussed above, the power outlet from such a generator can be provided as a power input to an ATS of the PALM system. Optionally, such generator is under the control of a genset controller incorporating a CAN node for signal communication with the CAN bus. Preferably the genset controller or battery controller implements a strategy for effective operation of the generator, including, for example, permitting up to three (3) attempts to start the generator. Upon three failures, preferably a signal is generated to a monitor included in the PALM system. Alternative responses will be readily apparent to those skilled in the art given the benefit of this disclosure.

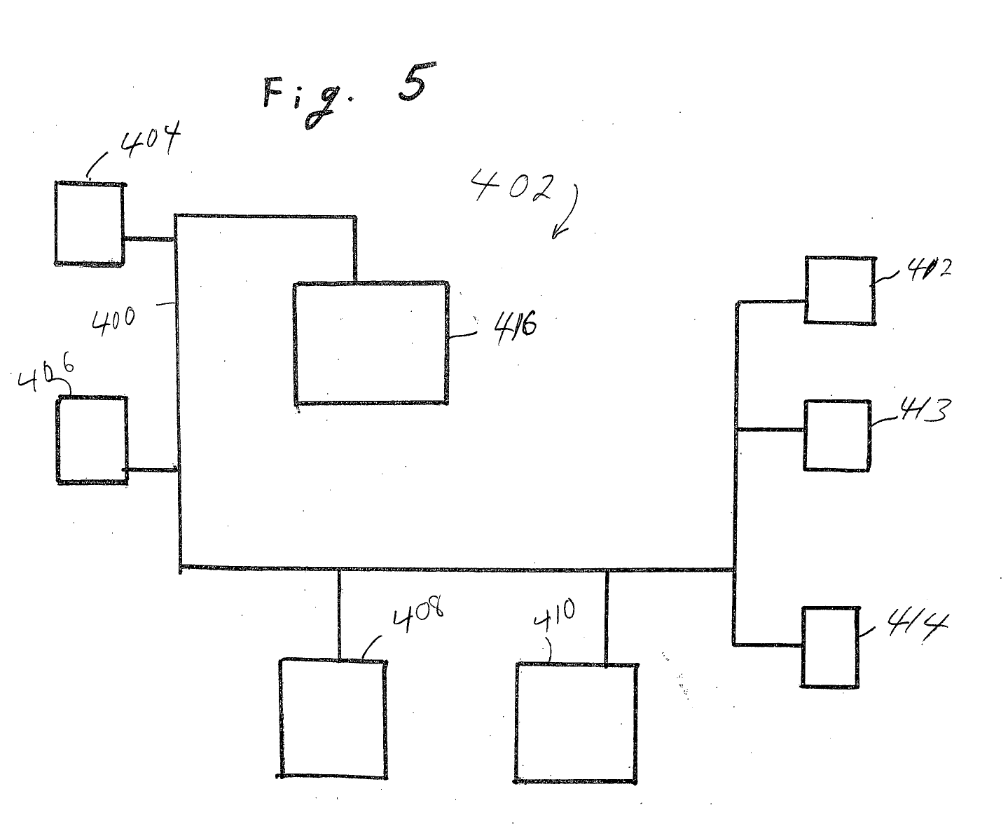

One embodiment of a PALM system in accordance with the present disclosure is schematically illustrated in FIG. 5. Communication line 400 represents both CAN communications and power transfer, as appropriate in the PALM system 402. The PALM system comprises ATS 404, distribution panel 406, battery management system 408, generator system 410, including a genset controller, and system loads 412-414. Each of the controllers of PALM system 402 communicate with monitor 416 via the RV's CAN network. It will be readily apparent that an RV may have more than the three representative loads shown in FIG. 5. One such load, for example, would typically be a furnace. Optionally, a furnace is provided as a furnace sub-system of the PALM system. Accordingly, the furnace would be powered through a power line controlled by the PALM system and the furnace would be under the control of a furnace controller incorporating a CAN node for communication via the RV's CAN bus with other components of the PALM system. Optionally, the furnace controller is incorporated into one of the other s PALM system controllers. The control may be either a single or dual BTU furnace control and preferably provides on/off heat control, hi/low heat control and/or hi/low vent control. In similar fashion, an air conditioning unit included in the RV can be provided as an air conditioning sub-system of the PALM system. Such air conditioning unit would be provided power over a power line from the distribution panel and would be controlled by an air conditioning controller incorporating a CAN node for communication via the CAN network. Alternatively, the air conditioning controller could be incorporated into one of the other controllers of the PALM system. Preferably the air controls include on/off control for the compressor, hi/low and off control for the fan, heat strip or heat pump on/off control and the like. In view of the present disclosure, it will be apparent to those skilled in the art that numerable other loads can be added to PALM system, that is, any number of power using devices etc., preferably controlled via CAN network communication and provided with power over the lines controlled by the PALM system.

As already noted, in certain embodiments of the power and load management system for a recreational vehicle, one or both of the two power transfer lines is connected (e.g., through a breaker, etc) directly to a load (or, more typically, where it is connected directly to each of a first set of loads) and through a particular distribution relay to a shedable load (or, more typically, where it is connected through a set of relays to corresponding ones of a set of loads). The distribution controller is operative to shed the shedable load by opening the corresponding relay, i.e., the particular distribution relay associated with that load. The other load(s) are connected “directly” in that power is fed to the load by the distribution panel from one or the other of the power transfer lines from the ATS without a load shedding relay or the like. Thus, such connection is direct in the sense that there is no relay controlled by the distribution controller that can drop the load. The power and current draw may nevertheless be sensed or measured by the distribution panel and taken into account in the power and load management, including, balancing, scheduling and prioritizing the loads and signaling the ATS for selecting the appropriate one or two power sources (from amongst the one, two or more available power sources) to power to be fed to the distribution panel.

An exemplary set of functions and CAN communications for a PALM system in accordance with the present disclosure is as follows:

### Palm System Node Functions and CAN Communications

| | |
|---|---|
| NODE NAME: | Automatic Transfer Switch |
| MODEL: | ATS4 |
| CONFIGURATION: | N/A |
| INPUTS | |
| A/D-I/O PARAMETERS: | Sources Present (4) |
| | Wiring Status Faults |
| | Input Voltages (4) |
| CAN messages: | |
| PARAMETERS: | N/A |
| USER CONDITIONS: | N/A |
| SYSTEM CONDITIONS: | N/A |
| COMMANDS: | Relays Settings (from PDP2) |
| OUTPUTS | |
| CONTROLS: | 12 VDC Control Currents to Relays (3) |
| CAN messages: | |
| PARAMETERS: | Input Voltages (4) |
| USER CONDITIONS: | N/A |
| SYSTEM CONDITIONS: | Relays Status (3) |
| | Sources Status (4) |
| COMMANDS: | N/A |
| NODE NAME: | Power Distribution Panel |
| MODEL: | PDP2 |
| CONFIGURATION: | Sources (Number, Maximum Current) |
| | Select Appliances |
| | (Number, Maximum Current) |
| INPUTS | |
| A/D-I/O PARAMETERS: | Circuits Currents: Select (3), Direct (1), |
| | Demands (3) |
| CAN messages: | |
| PARAMETERS: | [ATS4] - Input Voltages (4) |
| USER CONDITIONS: | [PMN1] - Shore service (15/20/30) |
| SYSTEM CONDITIONS: | [ATS4] - Relays Status, Sources Status |
| COMMANDS: | N/A |
| OUTPUTS | |
| CONTROLS: | Select Relays (3) and Drop Relays (3) |
| CAN messages: | |
| PARAMETERS: | Circuit Currents: Direct Max (3), |
| | Direct Usage (3), |
| | Select Max (3), Select Usage (3) |
| USER CONDITIONS: | N/A |
| SYSTEM CONDITIONS: | Select Demands (3), Charger Enable |
| COMMANDS: | ATS4 Relay Settings |
| NODE NAME: | Monitor |
| MODEL: | PMN1 |
| CONFIGURATION: | N/A |
| INPUTS | |
| A/D-I/O PARAMETERS: | Ambient light (internal use only) |
| CAN messages: | |
| PARAMETERS: | [ATS4] - Sources |
| | [PDP2] - ATS4 Relays Settings |
| | [PDP2] - Currents: Select Max (3), |
| | Select Usage(3), Direct |
| | Max (3). Direct Usage (3) |
| | [AC1] - Ambient T |
| | [USER] - Battery Voltage, |
| | Battery Current, Battery Type, |
| | Battery Rating |
| USER CONDITIONS: | N/A |
| SYSTEM CONDITIONS: | [GC1] - Failed Start |
| | [AC1] - Relays Settings (for verification!) |
| COMMANDS: | N/A |
| OUTPUTS | |
| CONTROLS: | N/A |
| CAN messages: | |
| PARAMETERS: | SOC, Battery Rating, Battery Type, Set T |
| USER CONDITIONS: | [AC1] and [FC1] Mode and Fan settings |
| SYSTEM CONDITIONS: | N/A |
| COMMANDS: | Battery Enable, Generator On/Off |
| NODE NAME: | Battery Management |
| MODEL: | BTM1 |
| CONFIGURATION: | Battery Type, Battery Rating |
| | (Overwritten by PMN1) |
| | Peukert's Coefficient, Charge Efficiency |
| INPUTS | |
| A/D-I/O PARAMETERS: | Battery Voltage, |
| | Battery Current, Battery T and |
| | Charge Current |
| CAN messages: | |
| PARAMETERS: | [PMN1] - SOC, Battery |
| | Type and Battery Rating |
| USER CONDITIONS: | Battery Enable/Off |
| SYSTEM CONDITIONS: | Charger Enable |
| COMMANDS: | N/A |
| OUTPUTS | |
| CONTROLS: | N/A |
| CAN messages: | |
| PARAMETERS: | Battery Type, Battery Rating, |
| | Battery Voltage, Battery Current and SOC |
| USER CONDITIONS: | N/A |
| SYSTEM CONDITIONS: | N/A |
| COMMANDS: | Battery Switch On/Off, |
| | Charger Switch On/Off |
| NODE NAME: | Generator Control |
| MODEL: | GC1 |
| CONFIGURATION: | N/A |
| INPUTS | |
| A/D-I/O PARAMETERS: | N/A |
| CAN messages: | |
| PARAMETERS: | N/A |
| USER CONDITIONS: | N/A |
| SYSTEM CONDITIONS: | N/A |
| COMMANDS: | [PMN1] - Start and Stop |
| OUTPUTS | |
| CONTROLS: | Start Relay, Stop Relay |
| CAN messages: | |
| PARAMETERS: | N/A |
| USER CONDITIONS: | N/A |
| SYSTEM CONDITIONS: | Run Status (Generator On/Off) |
| COMMANDS: | N/A |
| NODE NAME: | Battery Disconnect |
| MODEL: | BD2 |
| CONFIGURATION: | (Flush personality) |
| INPUTS | |
| A/D-I/O PARAMETERS: | N/A |
| CAN messages: | |
| PARAMETERS: | N/A |
| USER CONDITIONS: | N/A |
| SYSTEM CONDITIONS: | N/A |
| COMMANDS: | Battery On, Battery Off |
| | Charger On, Charger Off |
| OUTPUTS | |
| CONTROLS: | Battery Switch (On/Off) |
| | Charger Switch (On/Off) |
| CAN messages: | |
| PARAMETERS: | |
| USER CONDITIONS: | |
| SYSTEM CONDITIONS: | Battery Switch Flag, Charger Flag |
| COMMANDS: | N/A |
| NODE NAME: | Air Conditioner Control |
| MODEL: | AC1 |
| CONFIGURATION: | (Flush Personality) |
| INPUTS | |
| A/D-I/O PARAMETERS: | Ambient T |
| CAN messages: | |
| PARAMETERS: | Set T, Select Current Max, |
| | Select Current Usage |
| USER CONDITIONS: | Mode: Off/Cool/Heat/Fan Only |
| | Fan: Auto/High/Low/Medium |
| SYSTEM CONDITIONS: | [PMN1] - Inhibit (Disable) |
| COMMANDS: | |
| OUTPUTS | |
| CONTROLS: | Compressor(Cool), Fan High, Fan Low |
| | Optional: Fan Medium/Heat Strip |
| CAN messages: | |
| PARAMETERS: | Ambient T |
| USER CONDITIONS: | N/A |
| SYSTEM CONDITIONS: | Mode Status, Fan Status (Verification) |
| COMMANDS: | N/A |
| NODE NAME: | Furnace Control |
| MODEL: | FC1 |
| CONFIGURATION: | N/A |
| INPUTS | |
| A/D-I/O PARAMETERS: | N/A |
| CAN messages: | |
| PARAMETERS: | Set T |
| USER CONDITIONS: | Mode: Off/Cool/Heat/Fan Only |
| | Fan: Auto/High/Low/Medium |
| SYSTEM CONDITIONS: | N/A |
| COMMANDS: | N/A |
| OUTPUTS | |
| CONTROLS: | Heat On/Off |
| CAN messages: | |
| PARAMETERS: | N/A |
| USER CONDITIONS: | N/A |
| SYSTEM CONDITIONS: | Mode Status, Fan Status (Verification) |
| COMMANDS: | N/A |

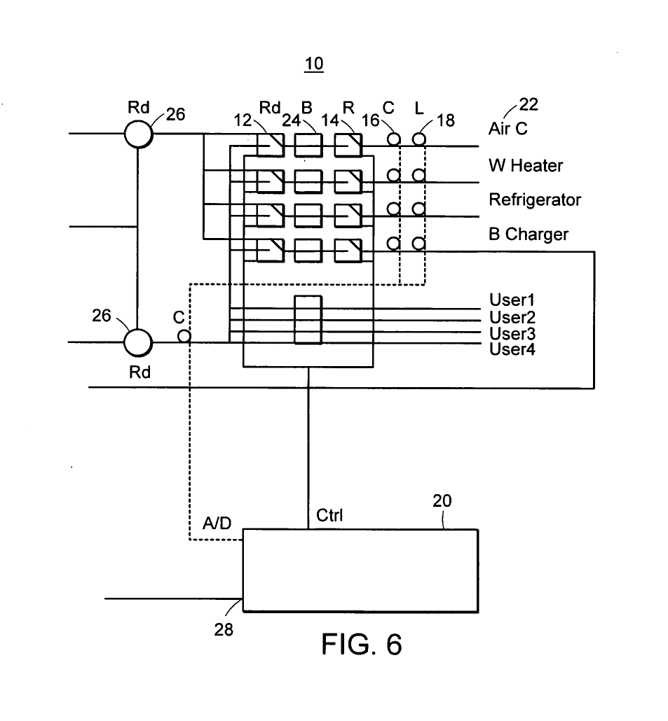

In the exemplary embodiment shown in FIG. 6, a distribution panel 10 and certain elements of an ATS for a PALM system for a recreational vehicle includes a first relay 12, a second relay 14, a current sensor 16, a power load sensor 18, and a controller 20. The first relay 12 is operative to select a power source from at least two power sources for power to be distributed to one or more selected power loads by the distribution system. The second relay 14 is in communication with the first relay 12 and operative to selectively drop the corresponding power load 22 from the distribution system 10. The current sensor 16 is operative to generate a signal in response to the current being drawn by the power load 22 on the distribution system 10. The power load sensor 18 is operative to generate a signal in response to the load 22 on the distribution system, that is, e.g., the impedance or resistance of the particular load, such as an air conditioning system, microwave or other appliance or electrical device or system. The controller 20 is in communication with the first and second relays 12, 14 and the current and power load sensors 16, 18 and is operative to activate the first and second relays 12, 14 to select a power source and to selectively add or drop a power load 22 based on signals received from the current and power load sensors 16, 18. The first relay 12, as shown in FIG. 6, serves to select between two or more power sources to be distributed to the power load. Preferably, the power being distributed is AC power such as typically used to power electric devices such as 110 Volts AC. As such the first relay 12 is of a type suitable to handle this type of power. Suitable relays are commercially available and will be apparent to those of ordinary skill in the art in view of this disclosure. Other applications may require other types of power, wherein the other suitable relays may be used. Other embodiments will be apparent to one skilled in the art given the benefit of this disclosure. The power sources available for selection by the first relay 12 preferably are provided by an ATS of the PALM system, as described above, and may include a generator on board the recreational vehicle, AC power from an inverter connected to a battery bank on-board the recreational vehicle, and a power source external to the recreational vehicle (“shore power”). These and other power sources are discussed in greater detail below. The second relay 14 as shown in FIG. 6, serves to selectively connect or disconnect the distributed power from a power source selected by the first relay 12, to the associated one of the power loads 22. This functionality may be used to drop or add the power load 22 from the power distribution system 10. The second relay 14 is preferably in electrical communication with the first relay 12. Alternatively, communication here and between any or all other controllers and/or other components of the PALM systems disclosed here can be optical, wireless, etc. In this particular embodiment the electronic communication is a wired connection between the first and second relays 12, 14 using a power cable suitable to carry the power being distributed. Preferably, the power being distributed is AC power such as typically used to power electric devices of an RV, such as 110 Volts AC. Suitable cables are commercially available and will be apparent to those of ordinary skill in the art in view of this disclosure. The second relay 14 is of a type suitable to handle this type of power as well. Suitable relays are commercially available and will be apparent to those of ordinary skill in the art in view of this disclosure. Other applications may require other types of power, wherein the other suitable cable and relays may be used. Other embodiments will be apparent to one skilled in the art given the benefit of this disclosure.

As used herein the term power load refers to electric devices that draw power. In the embodiment, as shown in FIG. 6, a power load may be an electric device typically used on a recreational vehicle. Examples of such power loads include air conditioners, water heaters, refrigerators, microwaves, and the like. Other devices will be apparent to one skilled in the art given the benefit of this disclosure.

The current sensor 16, as shown in FIG. 6, serves to monitor the current being drawn by a power load 22 on the power distribution system 10. In this embodiment, the current sensor 16 is in-line between the second relay 14 and the power load 22 thereby making it in electrical communication with the second relay 14 and the power load 22. The current sensor 16 detects the current being drawn by the power load 22 and generates an electric signal to the controller in response to the detected current. In some embodiments the generated signal may be proportional to the amount of current detected. In other embodiments the sensor 16 may generate a signal, e.g., a digital signal, corresponding to whether or not the monitored current meets a predetermined value. Other embodiments will be apparent to one skilled in the art given the benefit of this disclosure. Suitable sensors are commercially available and will be apparent to those of ordinary skill in the art in view of this disclosure.

The power load sensor 18, as shown in FIG. 6, serves to monitor the power load 22 placed on the power distribution system 10. In this embodiment, the power load sensor 18 is in-line between the second relay 14 and the power load 22 thereby making it in electrical communication with the second relay 14 and the power load 22. The power load sensor 16 detects the power load 22 and generates an electric signal in response to the detected power load. In some embodiments the generated signal may be proportional to the amount of power load detected. In other embodiments the sensor 18 may generate a digital signal upon the monitored power load meeting a predetermined value. Other embodiments will be apparent to one skilled in the art given the benefit of this disclosure. Suitable power load sensors are commercially available and will be apparent to those of ordinary skill in the art in view of this disclosure.

The controller 20 is in communication with the first and second relays 12, 14 and the current and power load sensors 16, 18. The controller is preferably in electrical communication with the first and second relays 12, 14 and the current and power load sensors 16, 18. The controller is operative to activate the first and second relays 12, 14 in response to signals received from the current and power load sensors 16, 18 and in certain exemplary embodiments also signals from one or more other controllers of the PALM system. The controller monitors the distribution system 10 using the current and power load sensors 16, 18 and selects a power source or drops a power load 22 accordingly by activating the first or second relay accordingly. Preferably, the controller 20 comprises a microprocessor. In other embodiments the controller 20 may comprise other components or circuitry. Other embodiments will be apparent to one skilled in the art given the benefit of this disclosure. Suitable microprocessors are commercially available and will be apparent to those of ordinary skill in the art in view of this disclosure.

In the embodiment shown in FIG. 6, the controller 20 comprising a microprocessor automatically activates the first and second relays 12, 14 and other controls according to its software package algorithms using the data it gathers from through the current and power load sensors 16, 18. The controller 20 or another controller of the PALM system may also provide connections or control for switches that allow a user to manually activate or set certain specific function. Examples of such functions include, but are not limited to, system start-up, battery disconnect, and generator enable. In some embodiments the controller 20 may have a remote control or display option for monitoring parameters of the system. For example, such remote control or display may be located in the passenger compartment of the RV. In certain embodiments the controller 20 may incorporate a CAN Node and connectors 28 to enable communication with a vehicle-wide communication bus, other controllers and/or electronic components of a recreational vehicle.

In the present embodiment, the software or firmware that the controller 20 runs is designed to optimize the utilization of all available power and to prevent demand overpower loads in the system. It does this by performing three major functions referred to here as: source selection; power load shedding; and power load sequencing. As part of source selection, critical power loads are switched to a different power source whenever the one currently in use becomes over-loaded. For example, an air conditioning unit can be switched from the shore supply to the battery bank inverter temporarily to meet peak demand. As part of power load shedding, selected power loads can be temporarily switched off to meet temporary peak demands. In certain embodiments the controller is provided with control software for selecting the sequence of loads to be shed. In some embodiments timers may be used to monitor an unsatisfied power load demand, that is, the controller can keep track of the amount of time a power load demand remains unsatisfied and control power distribution based at least in part thereon.

In power load sequencing, when the power load demands exceed the available power and one or more selected power loads must be at least temporarily shed from the distribution system, the power loads are sequenced to reduce or minimize the duration of unsatisfied power load demand(s). Sequencing may result in an initial delay in satisfying a power load demand or may cause a reduced service of some demands with or without significant degradation of performance, depending in part on the level of power available and the total load demand.

In the embodiment shown in FIG. 6, the distribution system 10 further comprises a set of circuit breakers 24, each in communication with the corresponding pair of first and second relays 12, 14. The circuit breaker 24 is operative to regulate power being distributed to a power load 22 on the distribution system. The second circuit breaker is preferably in electrical communication with the first and second relays 12, 14. In this particular embodiment the electronic communication is a wired connection between the first and second relay 12, 14 using a power cable suitable to carry the power being distributed. Preferably, the power being distributed is AC power such as typically used to power electric devices such as 110 Volts AC. The circuit breaker 24 is of a type suitable to handle this type of power. Suitable circuit breakers are commercially available and will be apparent to those of ordinary skill in the art in view of this disclosure. Other applications may require other types of power, wherein other suitable circuit breakers may be used. Other embodiments will be apparent to one skilled in the art given the benefit of this disclosure.

In the illustrated embodiment, the distribution system 10 comprises (or can be viewed, instead as being in communication with) a set of power relays 26, each operative to select a power sources from multiple possible power sources. These power relays 26 may be incorporated into and ATS of the PALM system and, for example, may be connected to three power sources such as a generator on the recreation vehicle, a battery bank on the recreation vehicle, and a power source outside the recreational vehicle. In certain exemplary embodiments these relays 26 allow any combination of two of the three power sources to be provided to the power distribution system 10 for selection by the first relay 12. Preferably these relays 26 are in electrical communication with the first relay 12. In this particular embodiment the electronic communication is a wired connection to the first relay 12 using a power cable suitable to carry the power being distributed. Preferably, the power being distributed is AC power such as typically used to power electric devices such as 110 Volts AC. The circuit breaker 24 is of a type suitable to handle this type of power. Suitable circuit breakers are commercially available and will be apparent to those of ordinary skill in the art in view of this disclosure. Other applications may require other types of power, wherein other suitable circuit breakers may be used. Other embodiments will be apparent to one skilled in the art given the benefit of this disclosure.

In some embodiments, the power distribution system 10 may comprise multiple first relays 12, second relays 14, current sensors 16, and power load sensors 18. In these embodiments the power distribution system comprises a first set of relays, each operative to select a power source from two power sources for power to be distributed to a corresponding one the RV's loads. Such power distribution system further comprises a second set of relays, each in communication with a corresponding relay of the first set of relays, operative to selectively drop power loads from the distribution system. Such power distribution system further comprises a set of current sensors operative to generate a signal in response to the current being drawn by power loads on the distribution system, a set of power load sensors operative to generate a signal in response to power loads on the distribution system, and a controller in communication with the first and second sets of relays and the sets of current and power load sensors, operative to activate the first and second sets of relays to select power sources and selectively add or drop power loads based on signals received from the current and power load sensors.

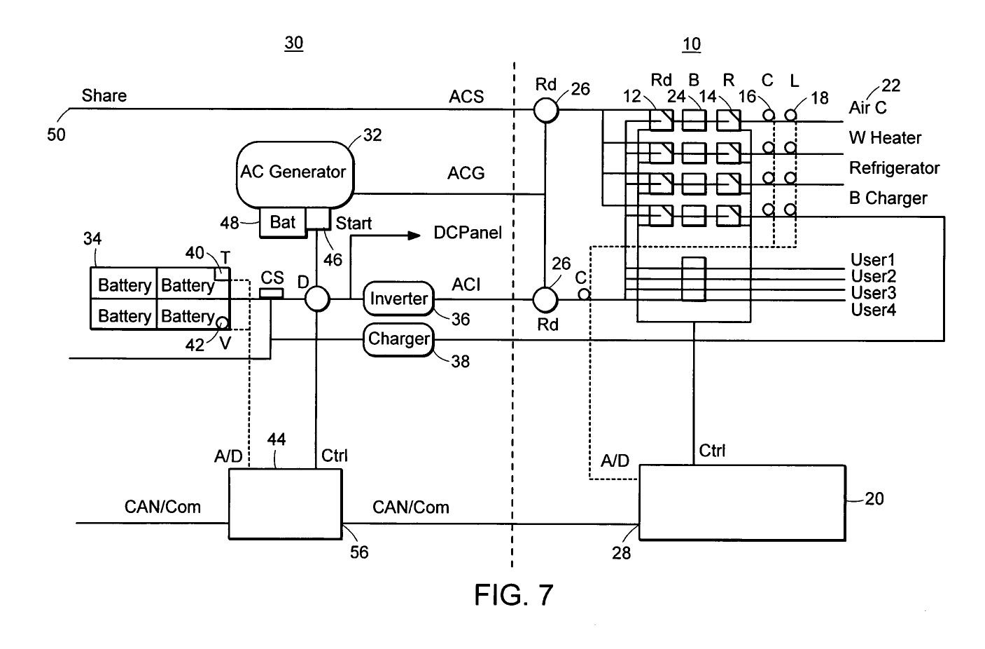

In the embodiment shown in FIG. 7, a power management system for recreational vehicles comprises a power distribution system for a recreational vehicle 10, as discussed above, and a power plant 30 in communication with the distribution system 10 and operative to provide at least two power sources to the distribution system. The power plant comprises a first alternative power source—generator 32, a second alternative power source—battery bank 34, and a third alternative power source—inverter 36, along with a charger 38, a battery bank temperature sensor 40, a battery bank voltage sensor 42 and a plant controller 44. As noted above, the plant controller optionally is divided into an ATS controller and a battery system controller.

The first power source 32 comprises a generator in communication with the distribution system 10. This generator is separate from the tradition power generating devices found in vehicles such as an alternator that power the vehicle itself. This generator is designed to provide power to the recreational vehicle for electric devices in the recreational vehicle. As such, the generator may have its own staring mechanism 46, including battery 48, allowing it to run independently from the rest of the recreation vehicle. The first power source 32 is preferably in electrical communication with the distribution system 10. In this particular embodiment the electronic communication is a wired connection using a power cable suitable to carry the power being distributed. Preferably, the power being distributed is AC power such as typically used to power electric devices such as 110 Volts AC. Suitable generators are commercially available and will be apparent to those of ordinary skill in the art in view of this disclosure. Other applications may require other types of power, wherein other suitable generators may be used. Other embodiments will be apparent to one skilled in the art given the benefit of this disclosure.

The second power source 34 comprises a battery bank in communication with the distribution system 10. This battery bank typically comprises two to four batteries, but may have as many as 8 or more batteries or as few as 1 battery. The battery bank is separate from the traditional battery associated with the RV's engine. The battery bank is preferably in electrical communication with the distribution system 10. In this particular embodiment the electronic communication is a wired connection using a power cable suitable to carry the power being distributed. Preferably, the battery bank is designed to provide power, typically 12 Volt DC, to the recreational vehicle for electric devices in the recreational vehicle. As such, the battery bank typically uses a different type of battery from those commonly used to power vehicles. Typically the battery used with the RV's engine is a starter battery capable of outputting high power for a short period of time for starting the engine, the primary use for such battery. The batteries used in the battery bank preferably are of a type that outputs moderate power over a longer period of time, which is better suited for providing DC power, or AC power using an inverter, to electric devices within the recreational vehicle. Suitable batteries are commercially available and will be apparent to those of ordinary skill in the art in view of this disclosure. Other applications may require other types of power, wherein other suitable batteries may be used. Other embodiments will be apparent to one skilled in the art given the benefit of this disclosure.

The inverter 36 is in communication with the second power source 34 and distribution system 10. The inverter 36 is preferably in electrical communication with the second power source 34 and distribution system 10. In this particular embodiment the electronic communication is a wired connection using a power cable suitable to carry the power being distributed. The inverter 36 is operative to convert DC power from the battery bank to AC power for the distribution system 10, typically 12 Volt DC to 110 Volts AC. The use of an inverter 36 allows the battery bank to provide AC power to the distribution system 10 for a short period of time. Suitable inverters are commercially available and will be apparent to those of ordinary skill in the art in view of this disclosure. Other applications may require other types of power, wherein other suitable inverters may be used. Other embodiments will be apparent to one skilled in the art given the benefit of this disclosure.

The charger 38 is in communication with the distribution system 10 and second power source 34. The charger 38 is operative to recharge the battery bank using AC power from the distribution system 10. Thus, when an AC power source, such as shore 50 or the generator, are being used to provide power to the distribution system 10 the battery bank can be recharged. The charger 38 is preferably in electrical communication with the distribution system 10 and second power source 34. In this particular embodiment the electronic communication is a wired connection using a power cable suitable to carry the power being distributed. Preferably, the charger 38 is of the type capable of converting 110 volts AC to 12 volts DC and recharging the battery bank in an efficient manner. Additional discussion of battery recharging is found herein below. Suitable chargers are commercially available and will be apparent to those of ordinary skill in the art in view of this disclosure. Other applications may require other types of power, wherein other suitable chargers may be used. Other embodiments will be apparent to one skilled in the art given the benefit of this disclosure.

The temperature sensor 40 is operative to generate signals in response to a measured temperature of the battery bank. The temperature sensor 40 detects the temperature of the battery bank and generates an electric signal to controller 44 in response to the detected temperature. In some embodiments the generated signal may be proportional to the temperature level detected. Suitable temperature sensors are commercially available and will be apparent to those of ordinary skill in the art in view of this disclosure. In other embodiments the sensor 40 may generate a digital signal upon the monitored temperature meeting a predetermined value. Other embodiments will be apparent to one skilled in the art given the benefit of this disclosure.

The voltage sensor 42 is operative to generate a signal in response to a measured voltage of the battery bank. The voltage sensor 42 detects the voltage level of the battery bank and generates an electric signal in response to the detected voltage. In some embodiments the generated signal may be proportional to the voltage level detected. Suitable voltage sensors are commercially available and will be apparent to those of ordinary skill in the art in view of this disclosure. In other embodiments the sensor 42 may generate a digital signal upon the monitored voltage meeting a predetermined value. Other embodiments will be apparent to one skilled in the art given the benefit of this disclosure.

The plant controller 44 is in communication with the generator 32, inverter 36, charger 38, temperature sensor 40, voltage sensor 42, and the distribution controller 28 of the distribution system 10. The plant controller 44 is preferably in electrical communication with the generator 32, inverter 36, charger 38, temperature sensor 40, voltage sensor 42, and the distribution controller 20. The plant controller 44 is operative to connect or disconnect the battery bank and activate or deactivate the generator and inverter 36, and control the charger 38 in response to signals from the sensors 40, 42 system controller 44. The plant controller 44 monitors the power plant using the temperature and voltage sensors 40, 42 and activates or de-actives the power sources 32, 34 accordingly as well as controlling the recharging of the battery bank. Preferably, the plant controller 44 comprises a microprocessor. Suitable microprocessors are commercially available and will be apparent to those of ordinary skill in the art in view of this disclosure. In other embodiments the plant controller 44 may comprise other components or circuitry. Other embodiments will be apparent to one skilled in the art given the benefit of this disclosure.

In the embodiment shown in FIG. 7, the plant controller 44 comprises a microprocessor, preferably loaded with software package algorithms for selection and operation of the power sources 32, 34 available to the power distribution system 10. It turns on or off the generator and inverter 36, connects or disconnects the battery bank, and monitors temperature, voltage, and current of the battery bank. The plant controller 44 may also receive signals or commands from the controller 20 of the power distribution system 10. In some embodiments, the controller 44 may incorporate a CAN Node and connectors 52 to enable communication with other controllers or electronic components of a recreational vehicle.

In the present embodiment, the software or firmware that the plant controller 44 runs is designed to provide a high degree of power averaging by performing three major functions: battery monitoring; battery charging; and source management. As part of battery monitoring, the state of charge of the battery bank is continuously monitored and updated using custom charging efficiency coefficients modified to reflect aging effects. Discharging is estimated or calculated in any suitable manner, e.g., using the Peukert's Equation combined with custom parameters, for example Peukert's exponent, which has been experimentally verified on the specific battery model in use. As part of battery charging, the software implements a four stage charging method to exploit the available power sources of the recreation vehicle utilize temperature compensation for best results. The first stage is a bulk charge at 50% of the battery bank amp-hour (Ah) rating. The second stage is a bulk charge at 25% of the battery bank amp-hour (Ah) rating. The third stage is the absorption stage. The fourth stage is the Float stage. Source management involves the control of the various elements of the power plant. This includes starting and stopping the generator, connecting and disconnecting the battery bank, and turning the inverter on and off.

In some embodiments, the recreational vehicles alternator may also be utilized as a power source. For example, the recreational vehicles alternator may be used for charging the battery bank. In such implementations, the plant controller my control the alternator to optimize recharging as part of the battery charging and source management functions. It should be understood that the term “optimize” and the like, as used in this disclosure and in the appended claims, means to a high degree or the like. It does not contemplate perfect maximization (or minimization, as the case may be), but rather good performance within the constraints of engineering and product design and manufacturing practicalities.

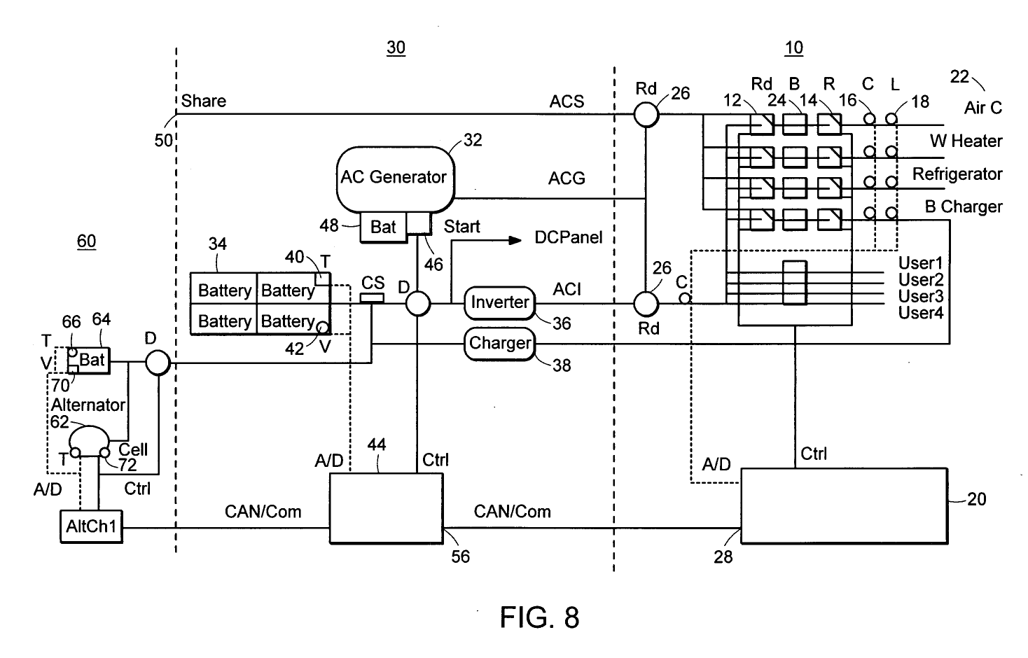

In the embodiment as shown in FIG. 8, a power management system for recreational vehicles comprises a power distribution system 10 for a recreational vehicle as discussed above, a power plant 30 as discussed above, and a chassis power system 60 in communication with the power plant 30 and, optionally power distribution system 10. The chassis power system comprises an alternator 62, a battery 64, a first temperature sensor 66, a second temperature sensor 68, a first voltage sensor 70, a second voltage sensor 72, and alternator control unit 74.

The alternator 62 is typically of a size and type for use in the particular recreational vehicle using it. The alternator 62 is typically used to provide power to the recreational vehicle while the vehicle is running. Suitable alternators are commercially available and will be apparent to those of ordinary skill in the art in view of this disclosure. Other embodiments will be apparent to one skilled in the art given the benefit of this disclosure. In some embodiments, such as shown in FIG. 8, the alternator my also be used as a power source for the power management system.

The battery 64 is in communication with the alternator 62. The battery 64 provides the starting power for the recreational vehicle. The battery 64 is in electrical communication with the alternator 62 whereby the alternator 62 may recharge the battery 64. The battery 64 is preferably of the type to provide the necessary power to the recreational vehicle it is being used in. Suitable batteries are commercially available and will be apparent to those of ordinary skill in the art in view of this disclosure. Other embodiments will be apparent to one skilled in the art given the benefit of this disclosure.

The first temperature sensor 66 is operative to generate a signal in response to a measured temperature of the battery 64. The first temperature sensor 66 detects the temperature of the battery 64 and generates an electric signal in response to the detected temperature. In some embodiments the generated signal may be proportional to the temperature level detected. Suitable temperature sensors for the battery are commercially available and will be apparent to those of ordinary skill in the art in view of this disclosure. In other embodiments the sensor 66 may generate a digital signal upon the monitored temperature meeting a predetermined value. Other embodiments will be apparent to one skilled in the art given the benefit of this disclosure.

The second temperature sensor 68 is operative to generate a signal in response to a measured temperature of the alternator 62. The temperature sensor 68 detects the temperature of the alternator 62 and generates an electric signal in response to the detected temperature. In some embodiments the generated signal may be proportional to the temperature level detected. Suitable temperature sensors for the alternator are commercially available and will be apparent to those of ordinary skill in the art in view of this disclosure. In other embodiments, the sensor 68 may generate a digital signal upon the monitored temperature meeting a predetermined value. Other embodiments will be apparent to one skilled in the art given the benefit of this disclosure.

The first voltage sensor 70 is operative to generate a signal in response to a measured voltage of the battery 64. The first voltage sensor 66 detects the voltage level of the battery 64 and generates an electric signal in response to the detected voltage. In some embodiments the generated signal may be proportional to the voltage level detected. Suitable voltage sensors for the battery are commercially available and will be apparent to those of ordinary skill in the art in view of this disclosure. In other embodiments the sensor 70 may generate a digital signal upon the monitored voltage meeting a predetermined value. Other embodiments will be apparent to one skilled in the art given the benefit of this disclosure.

The second voltage sensor 72 is operative to generate a signal in response to a measured voltage of the alternator 62. The second voltage sensor 72 detects the voltage level of the alternator 62 and generates an electric signal in response to the detected voltage. In some embodiments the generated signal may be proportional to the voltage level detected. Suitable voltage sensors for the alternator are commercially available and will be apparent to those of ordinary skill in the art in view of this disclosure. In other embodiments the sensor 72 may generate a digital signal upon the monitored voltage meeting a predetermined value. Other embodiments will be apparent to one skilled in the art given the benefit of this disclosure.

The alternator control unit 74 is in communication with the first and second temperature and voltage sensors 66, 68, 70, 72, the plant controller 44 and the system controller 20. The alternator control unit 74 is operative to control the alternator 62 to provide power to the recreational vehicle and recharge the battery bank of the power plant 30. The alternator control unit 74 is preferably in electrical communication with the first and second temperature and voltage sensors, the plant controller and the distribution system controller. The alternator control unit 74 is operative to control the traditional operation of the alternator for powering the vehicle and charging the battery in response to signals from the sensors or system controller. The alternator control unit 74 monitors the chassis power system using the temperature and voltage sensors 66, 68, 70, 72 and controls the operation of the alternator in response by generating the appropriate coil control currents. Preferably, the alternator control unit 74 comprises a microprocessor. Suitable microprocessors for the alternator control unit are commercially available and will be apparent to those of ordinary skill in the art in view of this disclosure. In other embodiments the plant controller may comprise other components or circuitry. Other embodiments will be apparent to one skilled in the art given the benefit of this disclosure.

In some embodiments, the alternator control unit 74 may also receive signals or commands from the plant controller 52 or the of the power distribution controller 20. In some embodiments, the alternator control unit 74 may incorporate a CAN Node and connectors 76 to enable communication with other controllers or electronic components of a recreational vehicle. For example, when the alternator is being used to recharge the battery bank of the power plant, operation of the alternator 62 may be controlled by the plant controller 44 so that recharging of the battery bank is performed in the method set forth in the description of the Battery Charging and Source Management functions.

While the invention has been described with respect to specific examples including presently preferred modes of carrying out the invention, those skilled in the art will appreciate that there are numerous variations and modifications of the above described systems and techniques that fall within the spirit and scope of the invention as set forth in the appended claims. Each word and phrase used in the claims is intended to include all its dictionary meanings consistent with its usage in the disclosure above and/or with its technical and industry usage in any relevant technology area. Indefinite articles, such as “a,” and “an” and the definite article “the” and other such words and phrases are used in the claims in the usual and traditional way in patents, to mean “at least one” or “one or more.” Also, reference to a system defined in a claim (or a sub-system, etc.) as having multiple of an item (e.g., multiple relays), where those items are then recited to have a particular feature or characteristic, allows the system (or sub-system) optionally also to have additional items of that general type (e.g., additional relays) not having that particular feature or characteristic. The word “comprising” is used in the claims to have its traditional open-ended meaning, that is, to mean that the system (or method, etc.) defined by the claim may optionally also have additional features, elements, etc. beyond those recited in the claims. Reference is made in certain of the claims to a “power source” (or to “power sources”) for context, clarity and/or convenience and not to mean that the power source(s) is (are) necessarily present, i.e., not to recite the power source(s) as a necessary element of the invention defined by the claim. For example, the phrase “multiple power inputs, each operative to be connected to one of multiple power sources” calls out the power inputs as a recited element of the claim; it does not require (but also does not necessarily exclude or prohibit) that the power sources be present Similarly, reference is made in certain of the claims to a “power load” (or to “power loads”) for context, clarity and/or convenience and not to mean that the power load(s) is (are) necessarily present, i.e., not to recite the power load(s) as a necessary element of the invention defined by the claim. For example, the phrase “multiple power inputs, each operative to be connected to one of multiple power sources” calls out the power inputs as a recited element of the claim; it does not require (but also does not necessarily exclude or prohibit) that the power sources be present. A reference above or in the claims below to a component being operative to perform one or more tasks or operations or the like is intended to mean that it is operative to perform at least the one or more tasks or operations, and may well be operative to perform also one or more other tasks or operations. In some instances, for clarity or emphasis a component is said expressly to be operative to perform at least one or more recited tasks or operations, and this does not in any way diminish the applicability of the preceding sentence to the other instances of statements of operability, etc.

1. A power and load management system for a recreational vehicle, comprising:
a power distribution panel comprising a distribution controller operative at least to generate distribution control signals including at least distribution relay control signals, and
a power transfer switch comprising:
multiple power inputs, each operative to be connected to a power source;
two power transfer lines to the power distribution switch;
multiple ATS relays, each controlled independently by power transfer control signals to connect and disconnect one of the power inputs to one of the power transfer lines, at least one of ATS relays being controllable to selectively connect any one of multiple power inputs to one of the power transfer lines;
multiple ATS sensors, each operative to generate a power availability signal corresponding to the availability of power on a corresponding one of the power input lines; and
an ATS controller operative at least to
receive power availability signals generated by the ATS sensors, and
generate the power transfer control signals to independently control the ATS relays in response to at least the power availability signals, and
to generate ATS signals to the distribution controller corresponding to power availability to the power distribution switch via the power transfer lines;
wherein the power distribution panel further comprises:
distribution relays, each controllable independently of the others in response to at least distribution relay control signals from the distribution controller, to selectively connect and disconnect each of the power transfer lines to a power load; and
a set of current sensors, each operative to generate a current draw signal corresponding to the current drawn by a corresponding power loads;
and wherein the distribution controller is in communication at least with the ATS controller, the distribution relays, and the current sensors and is operative to generate the distribution relay control signals in response to at least current draw signals and ATS signals.

2. The power and load management system for a recreational vehicle in accordance with claim 1 further comprising a battery management system comprising:
a battery bank,
an inverter operative to convert DC power from the battery bank to AC power fed by the power transfer switch to the distribution panel,
a generator operative to generate AC power fed by the power transfer switch to the distribution panel,
a temperature sensor operative to generate signals in response to a measured temperature of the battery bank,
a voltage sensor operative to generate a voltage signal in response to a measured voltage of the battery bank, and
a battery controller in communication with the generator, inverter, temperature sensor, voltage sensor, distribution controller and ATS controller, and operative to determine the state of charge of the battery bank and to generate a battery signal based on the state of charge to at least one of the distribution controller and the ATS controller.

3. The power and load management system for a recreational vehicle in accordance with claim 2 wherein the distribution controller, the ATS controller and the battery controller each comprises a CAN node for communication over a CAN bus.

4. The power and load management system for a recreational vehicle in accordance with claim 2 wherein the battery controller is operative to activate and deactivate the generator.

5. The power and load management system for a recreational vehicle in accordance with claim 2 wherein the battery management system further comprises a battery charger and the battery controller is operative to control the battery charger.

6. The power and load management system for a recreational vehicle in accordance with claim 1 further comprising a chassis power system comprising:
an alternator,
a chassis battery in communication with the alternator,
a first temperature sensor operative to generate a signal in response to a measured temperature of the battery,
a second temperature sensor operative to generate a signal in response to a measured temperature of the alternator,
a first voltage sensor operative to generate a signal in response to a measured voltage of the battery,
a second voltage sensor operative to generate a signal in response to a measured voltage of the alternator, and
an alternator controller in communication with the first and second temperature and voltage sensors and operative to determine the state of charge of the chassis battery and to generate a chassis battery signal based at least in part on the state of charge of the chassis battery to at least one of the distribution controller, the battery controller and the ATS controller.

7. The power and load management system for a recreational vehicle in accordance with claim 6 wherein the alternator controller is operative to control the alternator to provide power to the recreational vehicle through the power transfer switch.

8. The power and load management system for a recreational vehicle in accordance with claim 6 further comprising a battery management system comprising a battery bank operative to provide power to the recreational vehicle through the power transfer switch, wherein the alternator controller is operative to control the alternator to provide power to recharge the battery bank.

9. The power and load management system for a recreational vehicle in accordance with claim 1 further comprising a monitor for user interface with the power and load management system.

10. The power and load management system for a recreational vehicle in accordance with claim 9 wherein the monitor comprising a display screen and provides a screen select function whereby a subset of the available information is selected by a user for display.

11. The power and load management system for a recreational vehicle in accordance with claim 9 wherein the monitor comprises data displays including at least a climate control display and at least one selected from the group consisting of an AC power display, a DC power display and a generator display.

12. The power and load management system for a recreational vehicle in accordance with claim 1 wherein at least some of the distribution relays each is independently controllable to connect a corresponding power load to either of the power transfer lines.

13. The power and load management system for a recreational vehicle in accordance with claim 1 wherein a first one of the two power transfer lines is connected through a breaker
directly to each of a first set of loads, and
through a particular distribution relay to a shedable load, the distribution controller being operative to shed the shedable load by opening the particular distribution relay.

14. The power and load management system for a recreational vehicle in accordance with claim 13 wherein the second power transfer line is connected through a breaker
directly to each of a second set of loads, and
through a second particular distribution relay to a second shedable load, the distribution controller being operative to shed the second shedable load by opening the second particular distribution relay

15. The power and load management system for a recreational vehicle in accordance with claim 1 wherein
each of a first group of shedable loads is connectable only to the first one of the power transfer lines, each by a corresponding one of the distribution relays, and
each of a second group of shedable loads is connectable only to the second power transfer line, each through a corresponding one of the distribution relays,
the distribution controller being operative to shed any of the shedable loads by opening the corresponding distribution relay.

16. A power and load management system for a recreational vehicle, comprising, in combination:
a power distribution panel comprising a distribution controller operative to generate distribution control signals including at least
load signals corresponding to the power load demands on the power distribution panel, and
distribution relay control signals, and
a power transfer switch comprising
multiple power inputs, each operative to be connected to one of multiple power sources, and
two power transfer lines to the power distribution switch;
wherein the power transfer switch further comprises:
multiple ATS relays, each controlled independently to selectively connect either of the power transfer lines to any of the power inputs to feed power to the power distribution panel;
multiple ATS sensors, each operative to generate a power availability signal corresponding to the availability of power on a corresponding one of the power input lines; and
an ATS controller operative
to receive load signals from the distribution controller,
to receive power availability signals generated by the ATS sensors,
to generate the power transfer control signals to independently control the ATS relays in response to at least the power availability signals and the load signals, and
to generate ATS signals to the distribution controller corresponding to power availability to the power distribution switch via the power transfer lines;
wherein the power distribution panel further comprises:
a first set of distribution relays, each controlled independently of others of the first set of distribution relays, in response to at least distribution relay control signals from the distribution controller, to selectively connect one of the power transfer lines to at least one of a plurality of power loads; and
a set of current sensors, each operative to generate a current draw signal corresponding to the current being drawn on the distribution system by a corresponding one of the power loads; and
wherein the distribution controller is in communication at least with the ATS controller, the relays of the first set of distribution relays, and the current sensors, and is operative to generate the distribution relay control signals in response to at least current draw signals and ATS signals.

17. The power and load management system for a recreational vehicle, in accordance with claim 16, wherein the ATS relays are controlled in response to at least power transfer control signals from the distribution panel.

18. The power and load management system for a recreational vehicle, in accordance with claim 16, further comprising a second set of distribution relays, each in communication with a corresponding one of the first set of distribution relays and each controlled independently of others of the second set of distribution relays, in response to at least distribution relay control signals from the distribution controller, to selectively disconnect power to a corresponding one of the plurality of power loads, wherein the distribution controller is in communication with at least multiple ones of the relays of the second set of distribution relays.

19. The power and load management system for a recreational vehicle, in accordance with claim 16, further comprising a set of power load sensors, each operative to generate a power draw signal corresponding to the power drawn on the distribution system by a corresponding one of the plurality of power loads, wherein the distribution controller is in communication with at least multiple ones of the power load sensors and is operative to generate the distribution relay control signals in response to at least the current draw signals, the ATS signals and the power draw signals.

20. A power and load management system for a recreational vehicle comprising:
a first set of relays, each operative to select a power source from multiple available power sources for power to be distributed to a corresponding one of a plurality of power loads by the power distribution system;
a second set of relays, each in communication with a corresponding relay of the first set of relays and operative to selectively drop a corresponding one of the plurality of power loads from the distribution system;
a set of current sensors, each operative to generate a signal in response to the current being drawn by a corresponding one of the power loads on the distribution system;
a set of power load sensors, each operative to generate a signal in response to a corresponding one of the plurality of power loads on the distribution system; and
a distribution controller in communication with the first and second sets of relays and the current and power load sensors, operative in response to signals received by the controller from corresponding ones of the current and power load sensors
to control each of the relays of the first set of relays, independently of others of the relays of the first set of relays, to select a power source for the corresponding one of the plurality of power loads, and
to control each of the relays of the second set of relays, independently of others of the relays of the second set of relays, to add or drop the corresponding one of the plurality of power loads from the distribution system.

21. The power distribution system of claim 20 for a recreational vehicle, further comprising a third set of relays, each relay of the third set of relays being
b. positioned between a corresponding one of the power sources and a corresponding relay of the first set of relays, and
c. operative to select power from less than all of the available power sources to be provided to power loads by the distribution system.

22. The power distribution system of claim 20 for a recreational vehicle, wherein the distribution controller comprises a CAN Node and an associated CAN Node connector.

23. The power distribution system of claim 20 for a recreational vehicle, further comprising a circuit breaker in communication with a corresponding relay of the first set of relays and a corresponding relay of the second set of relays, operative to control power distributed to a power load by the power distribution system.

24. The power distribution system of claim 20 for a recreational vehicle, further comprising multiple available power sources, wherein at least one of the multiple available power sources comprises a generator.

25. The power distribution system of claim 20 for a recreational vehicle, further comprising multiple available power sources, wherein at least one of the multiple available power sources comprises a battery bank.

26. The power distribution system of claim 25 for a recreational vehicle, wherein the power source comprising a battery bank further comprises an inverter for transforming DC power to AC power.

27. The power distribution system of claim 20 for a recreational vehicle, further comprising multiple available power sources, wherein at least one of the available power sources comprises a source of shore power.

28. The power management system of claim 20 for a recreational vehicle, further comprising:
a power plant in communication with the power distribution system and operative to provide at least two power sources to the power distribution system, comprising:
a generator in communication with the power distribution system;
a battery bank in communication with the power distribution system;
an inverter in communication with the battery bank and power distribution system operative to convert DC power from the battery bank to AC power for the power distribution system;
a charger in communication with the power distribution system and battery bank operative to recharge the battery bank using AC power from the power distribution system;
a temperature sensor operative to generate signals in response to a measured temperature of the battery bank;
a voltage sensor operative to generate a signal in response to a measured voltage of the battery bank; and
a plant controller in communication with the generator, inverter, charger, temperature sensor, voltage sensor, and the distribution controller of the power distribution system and operative to connect or disconnect the battery bank and to activate or deactivate the generator and inverter, and to control the charger in response to signals from the sensors or distribution controller.

29. The power management system of claim 28 for a recreational vehicle, further comprising another set of relays for selecting at least two power sources from multiple power sources of the power plant to provide power to the power distribution system.

30. The power management system of claim 28 for a recreational vehicle, further comprising:
a chassis power system in communication with the power plant, the chassis power system comprising:
an alternator;
a chassis battery in communication with the alternator;
a first temperature sensor operative to generate a signal in response to a measured temperature of the chassis battery a second temperature sensor operative to generate a signal in response to a measured temperature of the alternator;
a first voltage sensor operative to generate a signal in response to a measured voltage of the chassis battery;
a second voltage sensor operative to generate a signal in response to a measured voltage of the alternator; and
an alternator control unit in communication with the first and second temperature and voltage sensors, the plant controller and the distribution controller and operative to control the alternator to provide power to the distribution controller and to recharge the battery bank of the power plant.
